(19) United States
(12) Patent Application Publication
(10) Pub. No.: US 2012/0017728 A1
(43) Pub. Date: Jan. 26, 2012

(54) SETTING TOOL FOR PROCESSING OR SETTING FASTENERS, BIT FOR PROCESSING FASTENERS AND BOLTS, PARTICULARLY THREADED BOLTS

(76) Inventor: Heiko Schmidt, Lappersdorf (DE)

(21) Appl. No.: 13/254,063

(22) PCT Filed: Feb. 18, 2010
(86) PCT No.: PCT/DE10/00188

§ 371 Date: Oct. 13, 2011

(30) Foreign Application Priority Data
Mar. 5, 2009 (DE) 10 2009 011 357.6
Jun. 17, 2009 (DE) 10 2009 025 646.6
Jul. 31, 2009 (DE) 10 2009 035 867.6

(51) Int. Cl. B23Q 7/10; F16B 23/00; B25B 13/02

(52) U.S. Cl. 81/57.37; 81/119; 411/403

(57) ABSTRACT

The invention relates to a setting tool for fasteners in the form of a hand-held tool, including a drive unit and a transfer and setting head that is drivably connected to the drive unit.

The invention relates to a setting tool according to the preamble of patent claim 1, which is suitable for processing or setting fasteners of a wide variety of types.

The invention furthermore relates to a bit according to the preamble patent claim 23, which is particularly suitable for processing or setting nuts or bolts or screw bolts. The invention furthermore relates to bolts, particularly threaded bolts or screws according to the preamble patent claim 31, which preferentially but not exclusively are suitable for processing with the setting tool or bit according to the invention.

The object of the invention is the creation of a setting tool particularly in the form of a hand tool, with which in a particularly rational manner and with high performance, processing or setting of fasteners is possible. To solve this object, a setting tool is designed according to patent claim 1.

A bit for processing or setting of fasteners, particularly in the form of nuts and/or bolts (also threaded bolts) is the subject of the patent claim 23. A bolt, particularly threaded bolt, which is especially but not exclusively suitable for processing with the setting tool according to the invention and/or with the bit according to the invention is the subject of the patent claim 31.

Fasteners in terms of the invention are particularly nuts, screws or threaded bolts, but also rivets, blind rivets, blind rivet nuts, blind rivet bolts, clips, locking ring bolts etc.

In general, setting in terms of the invention means among other things a joining and/or connecting of the respective fastener to a component or element etc.

In further development of the invention the setting tool is embodied for example so
that the transfer and setting head is connected in terms of drive to a drive unit for motorized dispensing and/or setting,
and/or
that the fasteners carried along with the transfer and setting head and/or held on the latter are dispensed from the magazine or the supply position,
and/or
that it is designed for the setting of fasteners in the form of nuts and/or bolts and/or threaded bolts and/or screws and/or rivets and/or blind rivets and/or blind rivet nuts and/or blind rivet bolts and/or clips and/or locking ring bolts,
and/or
that the transfer and setting head as bit, at least consisting of a socket forming tool flats for example in the form of an internal hexagon, is designed for the setting of the respective fastener and consisting of a spring-loaded holding element for holding the respective fastener carried along from the supply position during the setting stroke,
and/or
that the spring-loaded holding element is provided axially displaceably against the action of spring means within or without the socket,
and/or
that the transfer and setting head or its holding element is designed with at least one centring and holding pin engaging in an opening of the fastener, for example with a spring-loaded centring and holding pin,
and/or
that the spring-loaded holding element encloses the socket at least over a part region in the manner of a sleeve,
and/or
that on the transfer and setting head means are provided in order to hold the respective fastener on the transfer and setting head during the setting stroke, for example through clamping, magnetic force and/or through vacuum,
and/or
that the first axial direction is the axis of the transfer and setting head, for example the axis of rotation of the bit serving for the setting of the nuts and/or bolts,
and/or
that the magazine with a magazine longitudinal axis is orientated radially or approximately radially to the first axial direction,
and/or
that the magazine at least in a part region is orientated with its longitudinal axis parallel or approximately parallel to the first axial direction,
and/or
that the magazine is provided on the drive unit of the setting tool in a fixed manner,
and/or
that the magazine is removable and/or freely rotatable and/or lockable,
for example lockable on the drive unit and/or on a function element connection the transfer and setting head to the drive unit, for example on a function element connecting the transfer and setting head to the drive unit or to a drive there,
and/or
that the magazine and/or for receiving at least one auxiliary magazine containing the fasteners in sorted form is designed in multiple parts,
and/or
that the magazine is designed rod-shaped, spiral-shaped, bent or curved,
and/or
that the magazine for receiving the fasteners is designed in line or offset or separated through latching elements or in pre-magazined form for example in belted form,
and/or
the means for generating a feed of the fastener within the magazine are provided,
and/or
that the feed means are formed for example by at least one spring element or a spring-loaded pawl,
and/or
that the feed means bring about the feed pneumatically and/or electrically, magnetically and/or manually and/or hydraulically and/or through centrifugal force and/or gravity force and/or mass inertia force and/or through combinations of the abovementioned measures,
and/or
that the drive unit for the setting of the fasteners comprises a manual and/or motorized drive, for example a pneumatic and/or electric and/or magnetic and/or electromagnetic, hydraulic and/or pneumohydraulic drive and/or a drive actuated through spring force and/or through pressure accumulators,
and/or
that the drive of the drive unit is designed for setting the fasteners through pressing and/or pushing and/or through rotating and/or screwing and/or through pulling and/or through striking and/or through locking,
and/or
that the supply position and/or the dispensing opening are offset with regard to the magazine in the direction of the setting stroke,
and/or
that holding means, preferentially pawls and/or resilient holding means for holding the fasteners in the supply position and/or on a dispensing opening there are provided,
and/or
that the holding means can be moved along during the setting stroke,
and/or
that the pawls and/or holding means are provided in the supply position and/or on the dispensing opening there,
   wherein the abovementioned features of the setting tool can each be used individually or in any combination. In further development of the invention the bit is embodied for the setting of fasteners for example such,
that the holding element comprises means for holding the respective fastener through at least one magnetic field and/or through force fit and/or through vacuum,
and/or
that the holding element is provided axially displaceably in the socket,
and/or
that the holding element is designed with a centring and/or holding pin, which at least in a starting position of the holding element protrudes from the socket,
and/or
that the holding element is designed with a spring-loaded centring and/or holding pin, which in a starting position of the holding element protrudes from the socket,
and/or
that the holding element, at least enclosing the socket in a part region, is provided axially displaceably,
and/or
that it is designed for using cap nuts and/or of bolts and/or screws with a bolt head shaped according to the manner of a cap nut,
and/or
that it is part of a hand setting tool and hereby provided or formed preferentially on the free end of a shaft-like carrier connected in terms of drive to the drive of the setting tool,
   wherein the abovementioned features of the setting tool can each be used individually or in any combination.

As further development of the invention a bolt, particularly a threaded bolt or a screw, is embodied with a bolt or screw shank and with a polygonal tool driving region for example in the form of a hexagon on a bolt head for example such,
that the bolt head on the polygonal tool driving section is provided with an opening or centring and/or holding opening designed axially identically to the bolt axis,
and/or
that the bolt head is shaped in the manner of a cap nut, namely at least with one first head section following the bolt shank and radially standing away over the bolt shank, which is preferentially designed in the manner of a mushroom or truncated cone, and with a second head section following the first head section with a cross section that is reducing relative to the first head section,
and/or
that the second head section forms the polygonal tool driving section,
and/or
it is produced from a metallic material, preferentially steel or another ferromagnetic material,
   wherein the abovementioned features of the bolt or of the screw in each case can be used individually or in any combination.

Further developments, advantages and application possibilities of the invention are also obtained from the following description of exemplary embodiments and from the Figures. There, all features described and/or represented as image are principally the subject of the invention by themselves or in any combination, regardless of them being combined in the claims or their being referenced. The content of the claims is also made a part of the description.

In the following, the invention is explained in more detail with exemplary embodiments by means of the Figures. It shows:

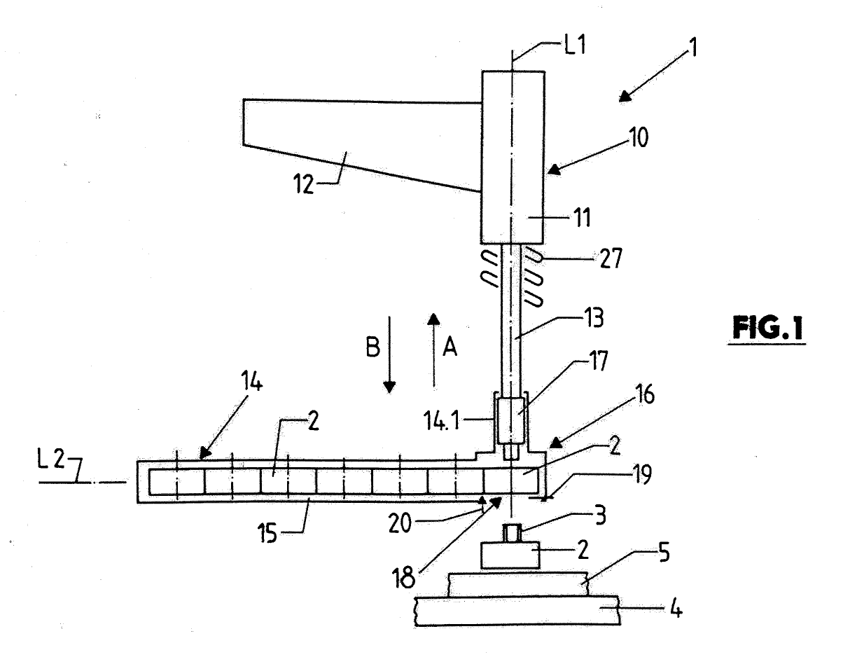

FIG. 1 in simplified schematic representation a setting tool for the manual processing of nuts according to the invention;

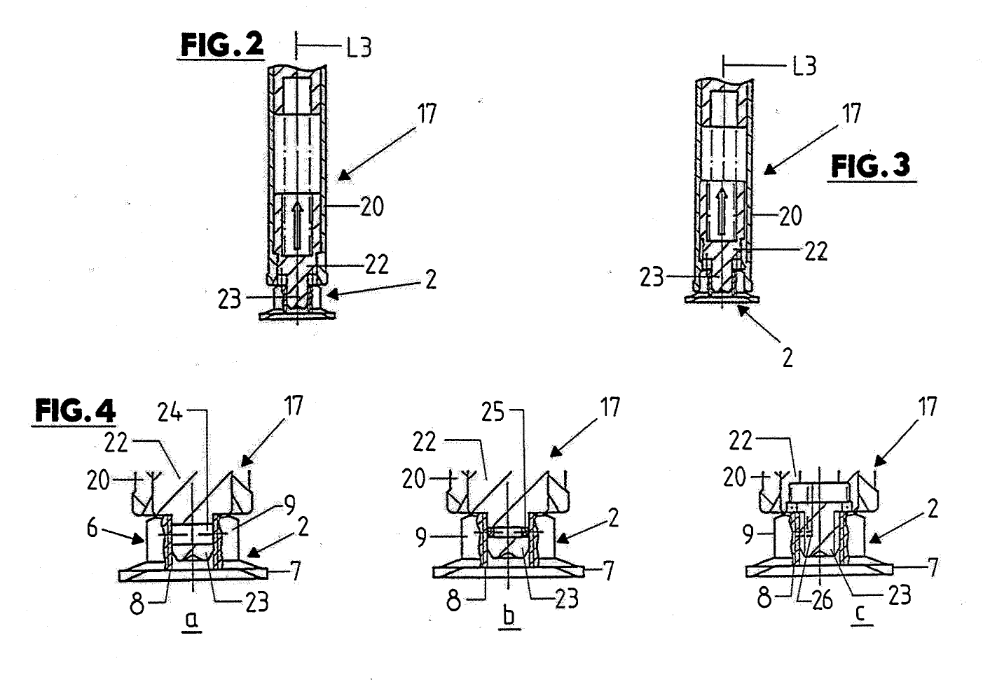

FIGS. 2 and 3 each in individual representation the bit of the processing tool of FIG. 1 together with a nut;

FIG. 4 in positions a-c different versions of the bit with regard to the holding of the respective nut on the spring-loaded holding element;

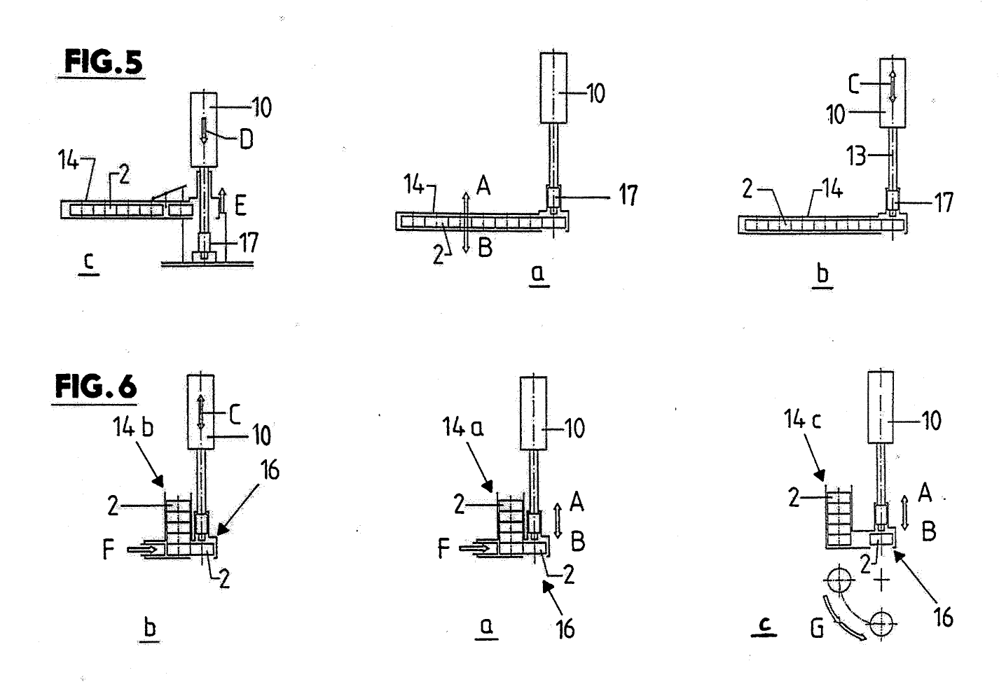

FIG. 5 in the positions a-c, different possibilities of reloading a fastener from the magazine extending radially to the bit or the axis of rotation of the bit;

FIG. 6 in the positions a-c, different methods of reloading a fastener from a magazine extending in direction of the axis of rotation of the bit or the bit carrier;

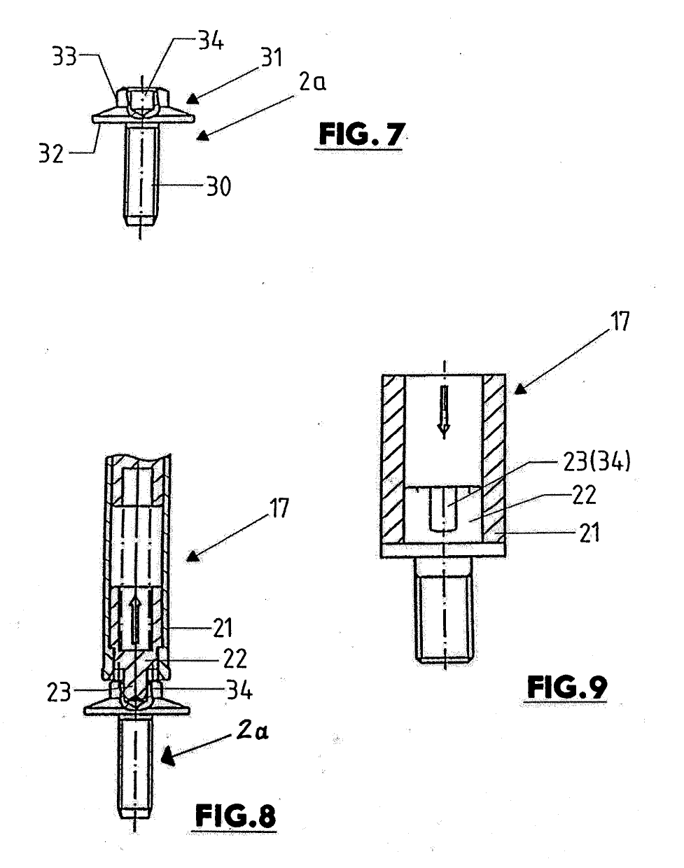

FIG. 7 in individual representation a bolt or a screw for processing with the bit of the FIGS. 2 and 3;

FIGS. 8 and 9 the bit together with the bolt in a representation similar to the FIGS. 2 and 3;

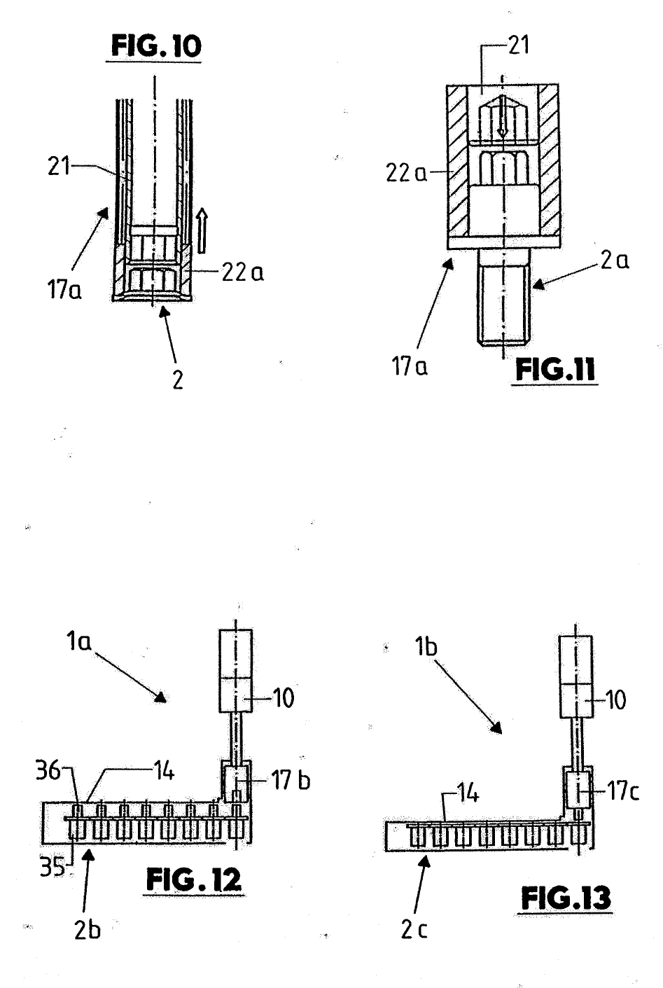

FIGS. 10 and 11 a further embodiment of the bit together with a fastener designed as nut or as bolt or screw;

FIGS. 12 and 13 in representations as per FIG. 1, further embodiments of the setting tool;

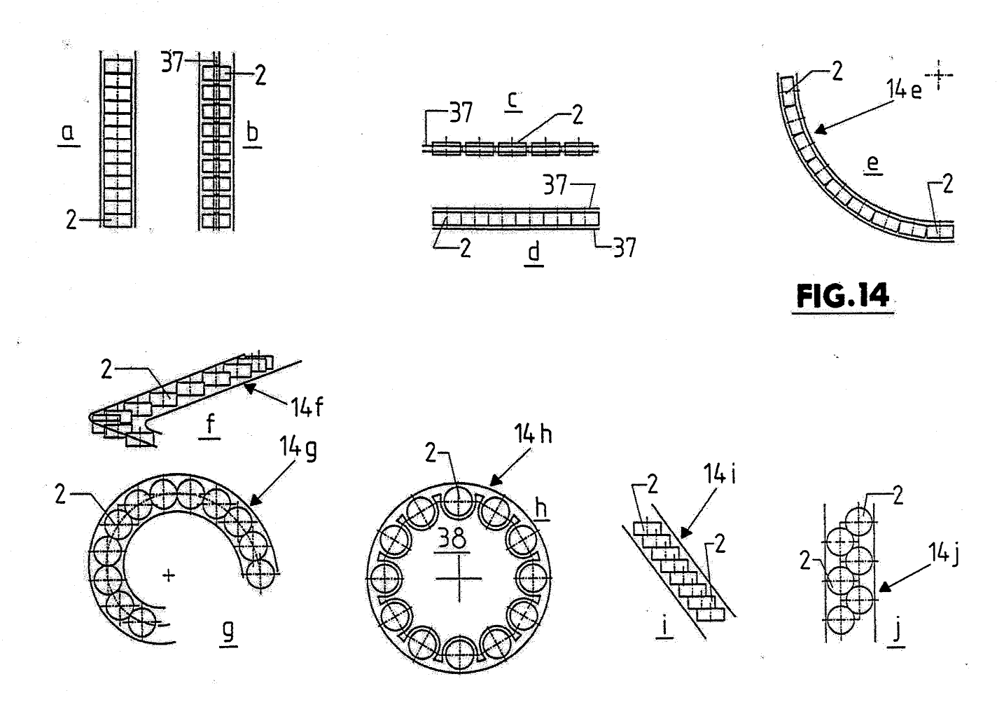

FIG. 14 in schematic representation and in the positions a-j, different possibilities of magazining of the fasteners;

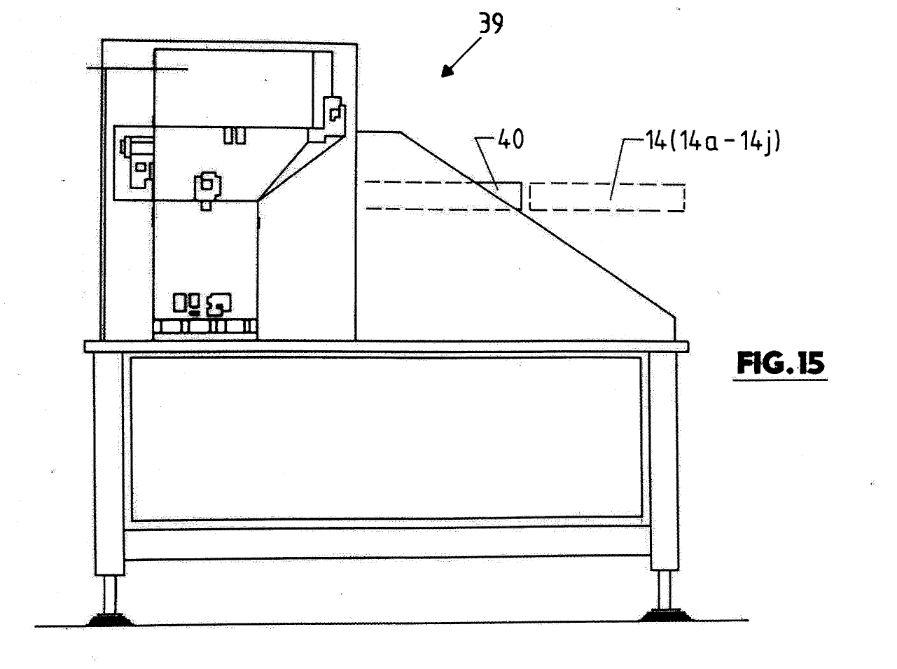

FIG. 15 in schematic representation a loading device;

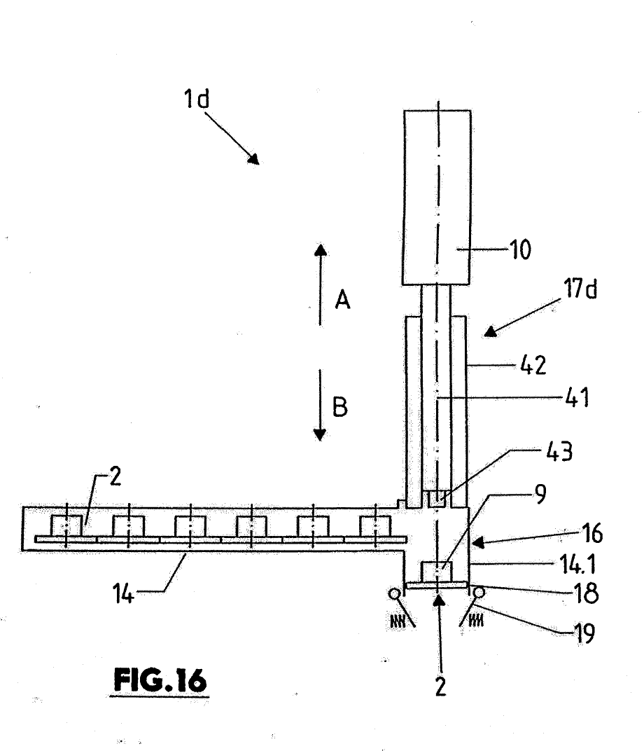

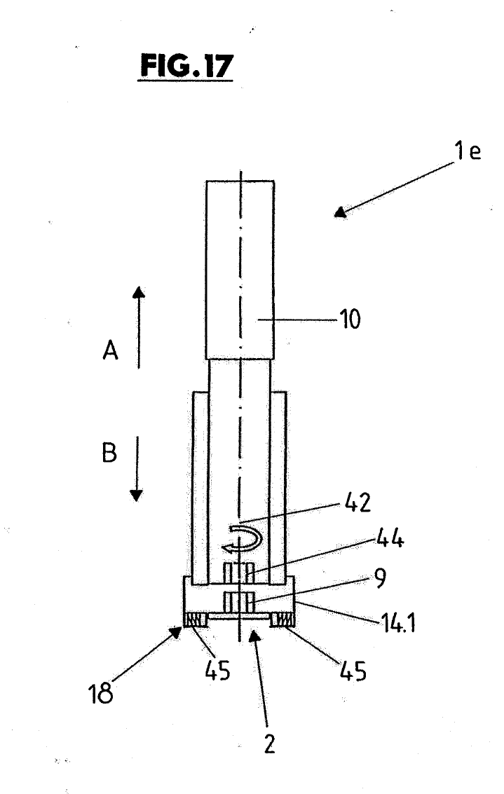

FIGS. 16 and 17 in schematic basic representations further embodiments of the setting tool according to the invention.

The setting tool generally designed 1 in the FIG. 1 serves for the manual processing or setting of fasteners in the form of nuts 2, i.e. for screwing the nuts 2 onto threaded bolts 3, which are provided on a component 4, namely for attaching or connecting a further component 5. The components 4 and 5 for example are parts of a vehicle body. The nuts 2 in each case are designed in the manner of a cap nut, namely with a nut body 6 having a protruding flange 7, with an internal thread 8 and an external hexagon 9.

The setting tool 1 substantially consists of a drive unit 10 designed for example in the manner of a conventional screwdriver with a drive accommodated in a housing 11 with a housing handle 12 laterally standing away, which for example is an electric motor drive, pneumatic or hydraulic drive. Preferably, the drive of the drive unit is an electric motor drive, which is driven by a rechargeable battery (accumulator) accommodated in the housing or in the housing handle 12.

In terms of drive, the drive of the setting tool 1 is connected to a transfer element or bit carrier 13 designed as shaft, namely in such a manner that with switched-on drive the bit carrier 13 is driven in rotating about its longitudinal axis L1.

The setting tool 1 furthermore comprises a magazine 14 for receiving a plurality of fasteners in the form of nuts 2. These are accommodated in series in the magazine 14 or in a guide 15 there, namely in such a manner that the nuts 2 closely follow one another in the guide 15, are orientated with their axes perpendicularly to the longitudinal axis L2 of the magazine 14 and the respective first nut 2 is located in a supply position designated 16 in FIG. 1 and formed at a magazine end or head 14.1. Through feed means which are not shown feeding of the nuts 2 from the guide 15 to the supply position 16 always takes place whenever a nut 2, which had been located in the supply position 16, has been processed so that after the processing of a nut 2 the next following nut 2 is available for processing.

With the setting tool 1 the magazine 14 is guided on the shaft-like bit carrier 13 with a sleeve-like section of the magazine head 14.1, namely in such a manner that the magazine 14 extends radially away from the bit carrier 13 and with its longitudinal axis L2 is orientated radially or perpendicularly to the longitudinal axis L1 in the embodiment shown. Furthermore, the magazine 14 can be pivoted about the axis L1 and with the magazine end 14.1 guided on the bit carrier 13 in such a manner that a relative movement of the drive unit 10 and of the magazine 14 in the axis L1 is possible, for example the magazine 10 can be displaced on the bit carrier 13 in the axis L1 as is indicated in FIG. 1 with the arrows A and B.

The basic mode of operation of the setting tool 1 can be described such that during the processing of the nuts 2 the nut 2 available in the supply position 16 in each case is grasped by a bit 17 provided on the bit carrier 13 through moving of the magazine 14 in the direction of the drive unit 10 (arrow A) and then continued to be held on the bit 17 and on the side facing away from the drive unit 10 moved out of the magazine 14 or from an opening 18 there for bearing against the threaded bolt 3 (feed stroke), so that the relevant nut 2 held on the bit 17 can be mechanically screwed onto the threaded bolt 3 with the bit 17 rotating about the axis L1 with the drive unit 10 switched on. Following this, the magazine 14 is manually moved back (arrow B) in the direction of the axis L1 in its starting position, so that the bit 17 is again located outside the supply position 16 and the dispensing opening 18 opposite and a further nut 2 can reach the supply position 16 out of the guide 15. With the setting tool 1, the bit 17 thus forms a transfer and setting head in interaction with the bit carrier 13. The respective nut 2 is locked in the supply position 16 through spring-loaded holding means, for example through spring-loaded pawls schematically indicated with 19 in FIG. 1 that can be pressed over upon dispensing the respective nut 2 from the supply position 16. Through additional retaining means for example likewise formed by at least one pawl, which are schematically indicated with 20 in FIG. 1 it is ensured that the next nut 2 queuing up in the guide 15 can only reach the supply position 16 when the magazine 14 is moved back into the starting position.

FIGS. 2-4 show in detail the bit 17 provided or formed on the free end, that is on the end of the bit carrier 13 located distant from the drive unit 10, for processing the nut 2. The bit 17 substantially consists of a socket 21, which forms an internal hexagon fitting the external hexagon 9 of the nuts 2, and a spring-loaded and axially displaceable holding element 22 arranged in the socket 21, which with its axis is arranged axially identical to the axis L3 of the bit 17 and thus also axially identical to the axis L1 of the bit carrier 13. Against the effect of spring means, the holding element 22 can be displaced in the direction of the axis L3 within the socket 21 from a starting position, in which the centring and holding pin 23 protrudes over the end of the bit facing away from the drive unit 10, namely in such a manner that the holding element 22 releases the socket 21 for receiving the section of the respective nut comprising the external hexagon 9.

On moving the nut 2 available in the supply position 16 out of the magazine 14 or out of the dispensing opening 18 with the bit 17 the nut 2 is initially held captively on the holding element 22 in a suitable manner according to the representations in FIGS. 2 and 4. When being screwed onto the threaded bolt 3 the nut 2 is pressed against the threaded bolt 3 with the setting tool 1, namely with the drive switched on, so that with rotating bit 17 the spring-loaded holding element 22 is moved back from its starting position into the socket 21 and because of this the external hexagon 9 of the nut 2 and the nut 2 is positively connected to the socket 21 for tightly turning on to the threaded bolt 3. In order to make possible screwing the nut 2 onto the respective threaded bolt 3 the centring and holding pin 23 has an effective length that is shorter than the axial length of the internal thread.

Holding of the nuts 2 on the holding element 22 can be realised in different manners, namely for example according to the position a of FIG. 4 when producing the nuts 2 from a ferromagnetic material through at least one permanent magnet 24 for example provided on the centring and holding pin 23, or according to the position b of FIG. 4 through clamping, for example through a clamping ring 25 provided on the centring and holding ring 23 or according to the position c of FIG. 4 through vacuum via vacuum channels 26.

Returning the magazine 14 into the starting position for reloading a new nut 2 from the guide 15 into the supply position 16 can be effected for example through spring or drive elements, thus for example in the simplest case through a compression spring surrounding the bit carrier 13 and supporting itself on the drive unit 10 and on the magazine, as is indicated with 27 in FIG. 1, or through pneumatic, hydraulic, electric, magnetic drive means which for example act directly or via further function and/or coupling elements onto the magazine 14 and/or the drive unit 10.

It was assumed, above, that the magazine 14 for moving the nuts 2 out of the supply position 16 and for reloading a further nut in the supply position 16 is moved relative to the drive unit 10, as is once more indicated in the position a of FIG. 5 with the arrows A and B. Obviously it is also possible to achieve the dispensing and reloading of the nuts 2 in that the drive unit 10 is moved relative to the magazine 14, as is indicated in the position b of FIG. 5 with the double arrow C there. With this design, it is possible, in particular, to provide the setting tool 1 on the magazine 14 with a foot-like support element 28, which is initially brought to bear against the component 4/5, upon which for dispensing the nut 2 available in the supply, position 16 and for screwing on this nut the drive unit 10 is moved relative to the magazine 14 supporting itself via the support element 28 according to the arrow D of the position c of FIG. 5 and following the screwing on or setting of the nut 2 and for reloading a further nut 2 in the supply position 16, is moved back into a starting position according to the arrow E.

It was assumed, above, that the magazine 14 with its longitudinal axis L2 is orientated radially to the axis of rotation and longitudinal axis L1 of the shaft-like bit carrier 13. Obviously, other embodiments are also conceivable. In the positions a-c of FIG. 6 setting tools 1 are represented in a highly schematic manner whose magazines 14a-14c are arranged with their longitudinal extension in each case parallel to the axis of rotation and longitudinal axis L1 of the bit carrier 13, specifically for receiving the nuts 2 in the form that these are orientated with the axis of their internal threads 8 in the direction of the magazine longitudinal axis L2. Reloading the supply position 16 with a nut 2 is effected by pushing out the respective first nut 2 available in the magazine 14a-14c into the supply position 16, namely in axial direction radially to the axis L1, as is indicated with the respective arrow F in the positions a and b of FIG. 6, or through a rotary movement in the form of an arc of a circle as is indicated in the position c of FIG. 6 with the arrows G, wherein the respective nut 2 upon reloading is moved perpendicularly to the axis of its internal thread 8. The pushing-out of the respective nut 2 from the magazine 14a-14c into the supply position 16 upon reloading in each case is affected for example manually or through suitable coupling or drive means, e.g. through the relative movement between the drive unit and the magazine 14a-14c concerned or through independent pneumatic, hydraulic, electric, spring-loaded and/or magnetic drive or delivery means, which then act on the nuts 2 either directly or via additional function or coupling elements.

The embodiments shown in the position a-c of FIG. 6 substantially differ in that with the setting tool 1 shown in the position a in turn for dispensing or for processing the nuts 2 and for reloading these nuts in the supply position 16 the magazine 14a is moved relative to the drive unit 10 (arrows A and B) and with the embodiment of the position b of FIG. 6 the drive unit 10 is moved relative to the magazine 14b (double arrow C), and that with the setting tool of the position c of FIG. 6 upon a relative movement between the magazine 14c and the drive unit 10 according to the position a or b the reloading of the nuts 2 in the supply position 16 does not take place radially to the axis L1, but on a curved path according to the arrows G.

The invention was described above in connection with a setting tool 1 for processing fasteners in the form of the nuts 2. Obviously, the setting tool according to the invention can also be used for processing fasteners of another form with suitable adaptation while maintaining the fundamental construction typical for the invention, for example for processing the screws or bolts 2a shown in FIG. 7, which substantially consist of the bolt shank 30 provided with an external thread and of the bolt head 31 moulded onto one end. With regard to its outer contour, the latter is moulded in accordance with the outer contour of the nuts 2, i.e. with a truncated cone or mushroom-like first head section 31.1 with circular circumferential surface and a second head section 33, which is provided with an external hexagon and follows the side of the head section 32 facing away from the bolt shank 30. The particular nature of the bolt 2a consists in that in the head section 33 arranged axially identically to the bolt shank 30 a centring and holding opening 34 which is open on the face end of this head section and likewise arranged axially identically to the bolt axis is provided, so that the bolts 2a can be likewise processed with the bit 17 or with a setting tool comprising this bit, as is particularly shown also in the FIGS. 8 and 9.

During processing, each bolt 2a is initially received and held by the spring-loaded holding element 22, wherein the centring and holding pin 23 engages in the opening 34. When pressing the bolt 2a with its end facing away from the bolt head 34 against a work piece or component in the region of a threaded bore there, the head section 33 provided with the external hexagon engages with the nut 21 through yielding of the holding element 22, so that the bolt is then turned into the appropriate threaded bore via the rotating bit 17.

FIGS. 10 and 11 as further embodiment show a bit 17a, which instead of the bit 17 can be used on a setting tool for processing fasteners in the form of the nuts 2 and/or the bolts 2a. The bit 17a differs from the bit 17 substantially in that with the bit 17a the socket 21 interacting with the external thread of the respective nut 2 or the respective bolt 2a is provided within the spring-loaded holding element 22a which is designed sleeve-like with this embodiment.

As is shown in FIG. 10, the respective nut 2 is held by the holding element 22a on the flange 7. Analogously, the respective bolt 2a is initially held by the holding element 22a on the head section 32 radially protruding over the head section 33 and upon the pressing of the bolt shank 30 against the work piece engages with the socket 21 with the external hexagon on the head section 33, namely upon the spring-loaded yielding of the holding element 22a. The bit 17a has the advantage that restraining elements 20 or corresponding pawls for retaining the fasteners in the magazine 14 are not required, since the sleeve-like holding element 22a acts as retaining element, i.e. forms a bearing surface for the fastener in the magazine 14 that is adjacent to the supply position 16 in each case and prevents that this fastener moves into the supply position before the bit 17a has returned into its starting position.

It was assumed, above, that the fasteners are nuts 2 or bolts 2a. Other fasteners can also be processed with the setting tool according to the invention if required with suitable adaptation of this tool to the type and/or shape and/or size of the fasteners. All embodiments then have in common that the fasteners are magazined, i.e. provided in a magazine and during setting the respective fastener available in the supply position 16 is grasped with the bit or transfer and setting head adapted to the type and/or shape and/or size of the fastener and is moved from the supply position into a setting position, i.e. into a position in which the fastener is to be fastened for example to a work piece. Following the retraction of the respective bit or of the transfer and setting head the supply position is reloaded with a new fastener.

Fasteners, in addition to the already described nuts 2 and bolts 2a among other things are also rivets, clips, locking ring bolts as well as blind rivet nuts or bolts or blind rivets in general.

In a representation similar to FIG. 1, FIG. 12 shows a setting tool 1a which is specifically designed for processing blind rivets 2b. The blind rivets 2b are of the known design, i.e. they substantially consist of a deformable rivet body 35 and a pin 36, which by being subjected to a suitable tensile force brings about the deformation of the rivet body 35.

The setting tool 1a initially differs from the setting tool 1 substantially only in that the magazine 14 or its guide 15 is designed for receiving the blind rivets 2b. Furthermore, the setting tool 1a comprises a transfer and setting head 17b instead of the bit 17, which is designed for the setting of the blind rivets 2b. The drive in the drive unit 10 is embodied accordingly, i.e. in the form that for deforming the respective rivet body 35 a suitable tensile force is exerted on the associated pin 36.

In a representation similar to FIG. 1, FIG. 13 shows a setting tool 1b which is specifically designed for the processing or rivet nuts 2c. The blind rivets 2c are of the know design.

The setting tool 1b initially differs from the setting tool 1 substantially only in that the magazine 14 or its guide 15 is designed for receiving the rivet nuts 2c. Furthermore, the setting tool 1b comprises a transfer and setting head 17c instead of the bit 17, which is designed for the setting of the rivet nuts 2c. The drive in the drive unit 10 is embodied accordingly.

It was assumed, above, that the arrangement of the fasteners, for example of the nuts 2, of the bolts 2a, of the blind rivets 2b or rivet nuts 2c in the respective magazine is provided in such a manner that these fasteners closely follow one another. Other types of magazining of the fasteners are possible.

In FIG. 14, the different possibilities of magazining the fasteners are reflected in the position a-j, which for the sake of simplicity are represented as nuts 2, but can also be fasteners of another type.

The position a of FIG. 14 shows a magazine storage corresponding to the magazines 14a-14c of FIG. 6, with which the fasteners are provided in a magazine stack-like on top of one another and closely following one another.

The position b of FIG. 14 shows a magazine storage, wherein the fasteners or nuts 2 are pre-magazined belted, namely on at least one belt in the manner that the fasteners with their axes are arranged parallel or substantially parallel to the longitudinal extension of the belt 37.

The positions c and d of FIG. 14 show a similar type of magazining subject to the use of a belt 37, on which the fasteners or nuts 2 are provided with their axis perpendicularly to the belt longitudinal extension.

The position d of FIG. 14 shows an embodiment with two belts 37 between which the fasteners or nuts 2 in each case are arranged with their axis perpendicularly to the belt longitudinal direction.

In the position e of FIG. 14 a magazine storage making use of a curved magazine 14e is shown.

The positions f-h of FIG. 14 each show a magazine storage of the fasteners or nuts 2 making use of a magazine 14f (position f) angled off multiple times, in the form of a magazine 14g (position g) curved in the form of an arc of a circle or a scroll and subject to the use of a magazine 14h comprising at least one separating disc 38 or a magazine 14h in the manner of a revolver. The positions i and j of FIG. 14 finally show embodiments of the magazining, wherein the fasteners or nuts 2 are arranged in the magazine 14i offset step-like relative to one another or arranged in the magazine 14j in two staggered rows.

Other types of magazining are possible. It is particularly also possible to design the respective magazine so that in this magazine an auxiliary magazine can be inserted, which contains the fasteners in magazined form and which following the consumption of the fasteners can be replaced with a further, filled auxiliary magazine.

The feed of the fasteners in the respective magazine 14, 14a-14j in the supply position 16 can be realised in different manners, for example through at least one spring element, through at least one spring-loaded pawl and/or pneumatically, electrically, manually, hydraulically, through centrifugal force, through the force of gravity, through mass inertia and/or through combinations of the aforementioned measures. The means causing the respective feed of the fasteners can act on the fasteners either directly or indirectly via additional function or coupling elements.

There is furthermore the possibility of providing the respective magazine not fixed to the setting tool 1 or 1a, but detachable, so that by exchanging the magazine the setting tool can be used for processing fasteners of different type, size, shape etc.

It was assumed, above, that the magazine and in this regard particularly the magazine 14 is freely rotatable about the axis L1, which is particularly practical in order to be able to move the magazine 14 standing away laterally out of a possible collision region when setting the fasteners. In principle, it is also possible to provide the magazine in a rotationally fixed manner or to create such a design that it can be locked in predetermined or random positions or locations in order to be able to for example single-handedly work with the setting tool 1, 1a or 1b and/or to be able to absorb torques with the hand gripping the magazine 14, 14a-14j when setting the fasteners, at least in a supporting manner.

The loading of the magazine 14, 14a-14j can be effected in different manners, for example through manually introducing fasteners in the magazine making use of pre-magazined fasteners or fasteners belted making use of belts, bands, adhesive tapes etc., through the use of an auxiliary magazine containing the fasteners in sorted form or through automatic loading of the respective magazine or auxiliary magazine with the fasteners making use of an automatic sorting and loading device 39, as is schematically shown in FIG. 15. The fasteners are fed to the loading device 39 in an unsorted quantity. Through suitable sorting and delivery means the fasteners are then introduced in a loading magazine 40 in a sorted manner, from which the respective magazine 14, 14a-14j of the setting tool 1 or 1a or the respective auxiliary magazine is loaded with the fasteners in a sorted manner.

It was assumed, above, that the magazine providing the fasteners for the processing is a part of the setting tool. There is also the possibility, in principle, that the magazine providing the fasteners or another device providing the fasteners for the processing is provided independently, for example in the form of a stationary magazine or in the form of a magazine that is carried by the respective user of the setting tool on his body, for example in the case of a right-handed person on the left arm or conversely in the case of a left-handed person on the right arm. Upon processing, the first fastener available in a supply or dispensing position of such a magazine is in each case grasped with the transfer or transmission head 17, 17a, 17b or 17c and drawn from the magazine and subsequently set with the setting tool. Furthermore, there is the possibility, in principle, to make the fasteners also available as loose bulk material, wherein each fastener upon processing is then manually placed onto the transfer and setting head or bit 17, 17a, 17b or 17c provided on the setting tool or on the drive unit 10 and subsequently processed.

FIG. 16 shows a setting tool 1d in a greatly simplified schematic representation that is very similar to the setting tool 1, which differs from the setting tool 1 substantially only in that the respective fastener, which in turn is represented in the form of a nut 2, is held in the supply position 16 in the magazine head 14.1 through the spring-loaded pawls 19 in such a manner that this nut 2, in the supply position 16, with the representation selected for the FIG. 16, is located below the magazine 14 and immediately on the dispensing opening 18 of the magazine head 14.1. The setting tool 1c in turn comprises the transfer or setting head 17d that is axially moveable relative to the magazine 14, which comprises the shaft or pushrod-type transfer element 41 connected in terms of drive to the drive unit 10 and the spring-loaded sleeve-like holding element 42 enclosing the transfer element 41 and is axially displaceable relative to the magazine head 14.1. The transfer element 41 is designed at its lower end with a centring and/or holding pin 43 for the respective nut 2.

The mode of operation of the setting tool 1d corresponds to the mode of operation as was described for the setting tool 1, i.e. the nut 2 available in the supply position 16 is dispensed from the magazine head 14.1 in the direction of the arrow B via the dispensing opening 18 through axial displacement of the transfer and/or setting head 17d, in the process placed on the respective work piece or component or a threaded bolt there and subsequently screwed onto the threaded bolt through the drive unit 10. The holding element 42 co-rotating with the transfer element 41 positively receives the nut 2 on its external hexagon 9 and thus causes the setting of the respective nut 2 through screwing-on. Preferably, with this embodiment, means are also provided with which the respective nut 2 upon being taken along with the transfer and setting head 17b is held on the latter, for example magnetically, through latching, snapping-on or in another suitable manner.

FIG. 17 shows the setting tool 1e as further embodiment, which substantially differs from the setting tool 1d in that with the transfer and setting head 17e the transfer element 41 with the centring and/or holding pin 43 has been omitted and the spring-loaded holding element connected in terms of drive to the drive unit 10 is provided with a recess or receptacle 44 with internal hexagon on its lower face end as bit or socket for the positive receiving of the hexagon section 9 of that nut 2, which is located in each case in the supply position 16 in the magazine head 14.1 and there held by spring-loaded holding elements 45. In order to make possible guiding the hexagon section 9 into the receptacle 44 it is ensured for example through suitable measures that each nut 2 in the supply position 16 is positioned with its hexagon section 9 in the correct position with respect to the internal hexagon of the receptacle 44, which for example can be achieved through turning or pivoting the holding element 42 and/or the magazine 14, or the design has been created such that the respective nut 2 arranged in the supply position 16 upon lowering and turning of the holding element 42 ultimately snaps into the receptacle 44 with its hexagon section 9 even if it was not correctly positioned with its hexagon section 9 initially. For setting, the respective nut 2 is guided along from the supply position 16 with the transfer and setting head 17e or with the holding element 42 and preferentially held on the holding element 42 for this purpose. The drive 10 is preferably controlled in such a manner that an alignment in the correct position of the respective fastener 2 with regard to the bit or the setting head 42/44 takes place.

If in the supply position 16 for example pawls 19 or other holding means, for example the spring-loaded holding elements 45 are provided, with which fasteners (2) that have been delivered or arranged in the supply position are held, it can be practical to guide these holding elements along, i.e. to axially move said holding elements along when setting the fastener. To this end, the pawls or holding elements are then provided on a function element or component of the setting tool concerned that is moved along with the holding or transfer element, for example the transfer element 41 or the holding element 42.

The invention was described above by means of exemplary embodiments. It is to be understood that numerous changes or modifications are possible without leaving the inventive idea on which the invention is based because of this.

Thus, it was assumed with the embodiments described above that the transfer and/or setting head with which the passing-on of the respective fastener from the magazine head to the work piece takes place, also serves for the setting or fixing of the fastener at the same time. In principle, embodiments with which a further function element of the processing or setting tool, for example the magazine head for setting or fixing the fastener is used, are also conceivable, for example through a movement, for example rotating movement of the magazine head.

With the embodiments described above it was furthermore assumed that particularly such fasteners as are set through screwing-on are in each case designed with a hexagon section. Obviously, instead of these hexagon sections, sections shaped in a different manner and usual with fasteners can also be provided, for example sections for a Torx connection or a Torx drive.

### LIST OF REFERENCE NUMBERS

1, 1a, 1b, 1d, 1e Setting tool
2 Nut
2a Bolt
2b Blind rivet
2c Blind rivet nut
3 Threaded bolt
4, 5 Component
6 Nut head
7 Flange
8 Internal thread
9 External hexagon
10 Drive unit
11 Housing
12 Housing handle
13 Co-carrier
14, 14a-14j Magazine
14.1 Magazine end or head
15 Guide
16 Supply position
17, 17a, 17b Transfer or setting head or bit
17c, 17d, 17e Transfer or setting head or bit
18 Dispensing opening
19 Pawls
20 Retaining element or pawl
21 Socket
22, 22a Holding element
23 Centring and holding pin
24 Permanent magnet
25 Clamping ring
26 Vacuum channel
27 Compression spring
28 Support element
30 Bolt shank
31 Bolt head
32, 33 Head section
34 Opening
35 Rivet body
36 Pin
37 Belt
38 Separating disc
39 Automatic sorting and loading device
40 Loading magazine
41 Transfer element
42 Holding element
43 Centring or holding pin
44 Opening with internal hexagon or co-section
45 Spring-loaded holding element for holding the nut located in the supply position 16

1-33. (canceled)

34. A setting tool for fasteners, with a transfer and setting head, comprising a magazine receiving a plurality of fasteners in orderly form, wherein the transfer and setting head and a section of the magazine forming a supply position is movable relative to each other at least in a first axial direction (L1) for a setting stroke (B) and a return stroke (A) in such a manner that in the setting stroke, a respective fastener, available in the supply position, is dispensed by the transfer and setting head for a subsequent setting on a work piece and further comprising means for moving a further fastener into the supply position after completion of the return stroke (A).

35. The setting tool according to claim 34, wherein the transfer and setting head is connected to a drive unit for motorized dispensing or setting.

36. The setting tool according to claim 34, wherein the fasteners are guided along with the transfer and setting head or held on the transfer and setting head and are dispensed from the supply position.

37. The setting tool according to claim 34, wherein the setting tool is for setting fasteners in the form of nuts, bolts, threaded bolts, screws, rivets, blind rivets, blind rivet nuts, blind rivet bolts, clips or locking ring bolts.

38. The setting tool according to claim 34, wherein the transfer and setting head is a bit consisting essentially of a socket forming tool flats in a form of an internal hexagon for setting the respective fastener and a spring-loaded holding element for holding the respective fastener guided along from the supply position during the setting stroke.

39. The setting tool according to claim 38, wherein the spring-loaded holding element is within or without the socket and is axially displaced against the spring-loading holding element.

40. The setting tool according to claim 38, wherein the transfer and setting head or the spring-loaded holding element has at least one centering and holding pin engaging in an opening of the fastener with a spring-loaded centering and holding pin.

41. The setting tool according claim 38, wherein the spring-loaded holding element encloses the socket in a sleeve-like manner.

42. The setting tool according to claim 34, wherein on the transfer and setting head means are provided to hold the respective fastener on the transfer and setting head during the setting stroke through clamping, magnetic force or through vacuum.

43. The setting tool according to claim 34, wherein the first axial direction (L1) is the axis of the transfer and setting head, and wherein the axis of rotation of the bit serving for the setting of nuts or bolts.

44. The setting tool according to claim 34, wherein the magazine is orientated with a magazine longitudinal axis (L2) radially or approximately radially to the first axial direction (L1).

45. The setting tool according to claim 34, wherein the magazine is orientated with a longitudinal axis (L2) parallel or approximately parallel to the first axial direction (L1).

46. The setting tool according to claim 35, wherein the magazine is provided in a fixed manner on the drive unit of the setting tool.

47. The setting tool according to claim 35, wherein the magazine is removable, freely rotatable or lockable, on the drive unit or on a function element connecting the transfer and setting head with the drive unit.

48. The setting tool according to claim 34, wherein the magazine or setting head is formed in multiple parts for receiving at least one auxiliary magazine containing the fasteners in sorted form.

49. The setting tool according to claim 34, wherein the magazine is rod-shaped, spiral-shaped, bent or curved.

50. The setting tool according to claim 34, wherein the magazine for receiving the fasteners is in line, offset or separated through latching elements or in pre-magazined form, or in belted form.

51. The setting tool according to claim 34, further comprising means for creating a feed of the fasteners within the magazine, wherein the feed means are formed by at least one spring element or a spring-loaded pawl and wherein the feed is pneumatically, electrically, magnetically, manually or hydraulically driven through centrifugal force, or gravity force, mass inertia force or through combinations of the aforementioned measures.

52. The setting tool according to claim 35, wherein the drive unit for setting of the fasteners comprises a manual or motorized drive, a pneumatic, electromagnetic, hydraulic, pneumohydraulic, electropneumatic, or electrohydraulic drive or a drive actuated by spring force or by a pressure accumulator.

53. The setting tool according to claim 35, wherein the drive of the drive unit is for a setting of the fasteners through pressing or pushing, through turning or screwing, through pulling, through striking or through locking.

54. The setting tool according to claim 34, further comprising holding means for holding the fasteners in the supply position or on a dispensing opening, and the holding means is moved along during the setting stroke (B).

55. The setting tool according to claim 54, wherein the pawls or spring-loaded holding means are in the supply position or on the dispensing opening.

56. A bit for setting fasteners that can be screwed and is provided with a polygonal tool driving section with a socket positively receiving the tool driving section wherein on the socket a spring-loaded holding element for holding the respective fastener is provided, and a holding element upon pressing of the fastener against a component or work piece is axially displaced against an effect of at least one spring element, subject to exposing a socket interior space receiving the polygonal tool driving section.

57. The bit according to claim 56, wherein the spring-loaded holding element comprises means for holding the respective fastener through at least one magnetic field, through force fit or through a vacuum.

58. The bit according to claim 56, wherein the spring-loaded holding element is axially displaceably in the socket.

59. The bit according to claim 56, wherein the spring-loaded holding element has a centering or holding pin, wherein the centering or holding pin, in a starting position of the holding element protrudes from the socket.

60. The bit according to claim 56, wherein the spring-loaded holding element enclosing the socket at least in a part region is provided axially displaceably.

61. The bit according to claim 56, wherein the bit is for the use with cap-like nuts, bolts or screws with a bolt head shaped in a manner of a cap nut.

62. The bit according to claim 56, wherein the bit is part of a hand setting tool in the form of a screwdriver and has on free ends of a shaft-like carrier connected in terms of drive to a drive of the setting tool.

63. A bolt with a bolt shank and with a polygonal tool driving section on a bolt head, wherein the bolt head on the polygonal tool driving section is provided with an opening axially identical to a bolt axis.

64. The bolt according to claim 63, wherein the bolt head is a cap nut, at least with one first head section radially standing away over the bolt shank and following the bolt shank, and with a second head section following the first head section with a cross section that is reduced relative to the first head section, and in that the second head section forms the polygonal tool driving section.

65. The bolt according to claim 63, comprising a metallic material, a steel or a ferromagnetic material.

66. The setting tool according to claim 34, wherein the supply position or a dispensing opening are staggered relative to the magazine in a direction of the setting stroke (B).
